(19) United States
(12) Patent Application Publication
(10) Pub. No.: US 2014/0126680 A1
(43) Pub. Date: May 8, 2014

(54) NICKEL ALLOYS FOR HYDROGEN STORAGE AND THE GENERATION OF ENERGY THEREFROM

(71) Applicant: Han H. Nee, Newport Coast, CA (US)

(72) Inventor: Han H. Nee, Newport Coast, CA (US)

(73) Assignee: TARGET TECHNOLOGY INTERNATIONAL , LTD., Tortola (VG)

(21) Appl. No.: 14/119,400

(22) PCT Filed: May 30, 2012
(86) PCT No.: PCT/US2012/040017

§ 371 Date: Nov. 21, 2013

Related U.S. Application Data
(60) Provisional application No. 61/519,889, filed on Jun. 1, 2011.

(51) Int. Cl. C22C 19/03; H05B 1/02; C22C 1/04

(52) U.S. Cl. CPC C22C 19/03; C22C 1/04; H05B 1/023
USPC 376/156; 419/66; 75/228; 75/235; 75/232; 219/201

(57) ABSTRACT

An apparatus for the generation of thermal energy comprises a reactor vessel containing a volume of pressurized hydrogen; a hydrogen-storing nickel alloy structure in the reactor vessel and configured to have an electric potential applied across it and to be heated to at least about 100 C; and a heat exchange conduit configured to carry a heat exchange medium past the nickel alloy structure so as to allow thermal energy generated in the nickel alloy structure to be transferred to the heat exchange medium. The hydrogen-storing nickel alloy structure comprises a nickel alloy skeletal catalyst mixed with an oxide. The applied electric potential, and the increase in the gas pressure and temperature of the hydrogen from the applied heat, create a reaction between hydrogen nuclei and nickel nuclei in the nickel alloy structure whereby thermal energy is generated by the emission of phonons from the nickel alloy structure.

### CROSS-REFERENCE TO RELATED APPLICATION

This application claims priority, under 35 U.S.C. §119(e), from U.S. Provisional Application No. 61/519,889, filed Jun. 1, 2011, the disclosure of which is incorporated herein by reference in its entirety.

### FEDERALLY SPONSORED RESEARCH OR DEVELOPMENT

Not applicable

### BACKGROUND

This disclosure relates to nickel alloys that are capable of acting as catalysts for processes involving the storage of hydrogen, hydrogenation, dehydrogenation, and hydrogenation reaction processes. The disclosure further relates to methods of making these alloys and to the generation of thermal energy therefrom.

It is known to use certain metals, such as palladium (Pd), to store hydrogen, particularly its deuterium isotope (D₂), in connection with attempts to achieve low energy nuclear reactions. These attempts have, to date, failed to achieve sufficient repeatability or predictability to be of any practical use. Furthermore, the need for the relatively rare and expensive metal palladium would further limit any commercial-scale use of these processes, especially since such processes would need to compete with the very high demand for palladium for use in catalytic converters for internal combustion engines. Dependency on hydrogen with enhanced concentrations of deuterium further increases costs. Thus, it would be desirable to achieve low energy nuclear reactions that are repeatable and predictable using a lower cost metal or metal alloy, as well as hydrogen with its naturally-occurring isotopic distribution, thereby offering greater promise of practicality on a commercial scale.

One category of alloys that has been the subject of investigation for hydrogen storage is nickel (Ni) alloys. Specifically, numerous nickel alloys are known that are capable of storing hydrogen for the generation of electrical energy by electrochemical processes. Such alloys are used, for example, in electrical batteries, particularly of the nickel metal hydride (NiMH) type. To date, however, the Ni alloys used do not sufficiently catalyze the hydrogen reaction processes to achieve low energy nuclear reactions.

Accordingly, it is desired to provide nickel alloys that are capable of storing hydrogen in a mariner that allows low energy nuclear reactions to be achieved between nickel and hydrogen nuclei at relatively “low” temperatures (e.g., no more than about 1,000° C.). It is further desired to provide a process and apparatus for producing thermal energy by means of such “low temperature” nuclear reactions through the storage of hydrogen in nickel alloys.

### SUMMARY

A first aspect of the present disclosure relates to nickel alloy structures that store hydrogen so as to increase the catalysis of low energy nuclear reactions. A second aspect of the disclosure relates to methods of making such structures. A third aspect of the disclosure relates to methods and apparatuses for the production of thermal energy from low temperature nuclear reactions involving hydrogen dissolved and stored in such nickel alloy structures.

In accordance with certain embodiments of the first aspect of the disclosure, the nickel alloys include nickel combined with one or more of aluminum, lithium, zinc, molybdenum. manganese, titanium, iron, chromium. and cobalt. The nickel alloys may also include one or more non-metallic elements selected from the group consisting of carbon, silicon, and boron. The nickel alloys may optionally be further combined with one or more oxides selected from the group consisting of oxides of a transition metal, oxides of an alkali metal, oxides of an alkali earth metal, and oxides of an element in any of Groups III-A, IV-A, V-A, and VI-A of the Periodic Table.

In accordance with the second aspect of the disclosure, a method of making a hydrogen-storing nickel alloy structure includes (a) melting a precursor alloy, where the precursor alloy comprises approximately 35%-50% by weight nickel, the remainder being one or more alloying metals selected from the group consisting of aluminum, lithium, zinc, molybdenum, manganese, titanium, iron, chromium, and cobalt, and, preferably, one or more materials selected from the group consisting of boron, carbon and silicon; (b) quenching the melted precursor alloy to room temperature; (c) grinding the quenched alloy to produce an alloy powder; (d) screening the alloy powder to a desired particle size; (e) etching the screened alloy powder to remove any extraneous amounts of the metal or metals alloyed with the nickel, thereby producing a nickel alloy skeletal catalyst powder; (f) washing the nickel alloy skeletal catalyst powder; (g) drying the nickel alloy skeletal catalyst powder; (h) mixing a powdered oxide into the nickel alloy skeletal catalyst powder to form a nickel alloy/oxide powder; and (i) forming the nickel alloy/oxide powder into a hydrogen storing nickel alloy structure.

In accordance with the third aspect of the disclosure, an apparatus for the generation of thermal energy comprises a reactor vessel configured to contain a volume of pressurized hydrogen; a hydrogen storing nickel alloy structure contained in the reactor vessel and configured to have an electric potential applied across it and further configured to be heated to a temperature of at least about 100° C.; and a heat exchange conduit configured to carry a heat exchange medium past the nickel alloy structure so as to allow thermal energy generated in the nickel alloy structure to be transferred to the heat exchange medium. Also in accordance with the third aspect, a method of providing thermal energy comprises (a) providing a hydrogen storing nickel alloy structure in a reactor vessel; (b) filling the reactor vessel with hydrogen; and (c) applying an electric potential across the nickel alloy structure while heating the hydrogen and the nickel alloy structure to a temperature of at least about 100° C.; wherein the applied electric potential, and the increase in the gas pressure and temperature of the hydrogen from the applied heat, create a nuclear reaction between hydrogen nuclei and nickel nuclei in the nickel alloy structure, the nuclear reaction generating thermal energy in the emission of phonons from the nickel alloy structure.

### BRIEF DESCRIPTION OF THE DRAWINGS

FIG. 1 is a flowchart showing the steps in a method of making a hydrogen storing nickel alloy structure in accordance with an aspect of the disclosure; and

FIG. 2 is semi-diagrammatic view of an apparatus for generating thermal energy in accordance with an aspect of the disclosure.

### DETAILED DESCRIPTION

### 1. Hydrogen Storing Nickel Alloys

In accordance with this disclosure, nickel alloys are described that increase the catalysis of low energy nuclear reactions that are fueled by the isotopes of hydrogen. These isotopes—hydrogen (H₂), deuterium (D₂), and tritium (T₂)—may be used singly or in combination. although typically (and as used throughout this disclosure) the word “hydrogen” and the symbol H₂ will mean naturally-occurring hydrogen with its isotopes in their normal proportions, unless a specific isotope is specified.

The hydrogen storing structure described below may be made, in an embodiment of the disclosure, with a process that begins with a precursor alloy preferably constituting about 35%-50% nickel by weight. The balance of the alloy may be one or more alloying metals selected from the group consisting of aluminum, lithium, zinc, molybdenum, manganese, titanium, iron. chromium, and cobalt, with aluminum being preferred. One or more non-metallic materials selected from the group consisting of carbon. silicon, and boron may advantageously be added in small quantities (no more than about 10% by weight in total). The alloying metals may optionally be present in their oxide forms, instead of, or in addition to, their elemental forms. As will be described more fully below, during the manufacturing process, a “skeletal catalyst” alloy is produced, from which the nickel hydrogen storing structure is formed. Table I presents some exemplary formulations for the skeletal catalyst alloy in accordance with embodiments of this disclosure.

TABLE 1

| | | Preferred Percentage |
|---|---|---|
| Alloying Element | Percentage by Weight | by Weight |
| Ni | >80% | >90% |
| C (if present) | about 0.01 to about 0.6 | about 0.01 to about 0.6 |
| Si (if present) | about 0.01 to about 10.0 | about 0.1 to about 5.0 |
| B (if present) | about 0.001 to about 0.010 | about 0.001 to about 0.010 |
| Al, Ti, Zn, Mo, | about 0.01 to about 15 | about 1.0 to about 10 |
| Mn, Fe, Cr, Li, | | |
| and/or Co | | |

Various oxides may advantageously be added to the aforementioned alloys. For example, oxides of one or more of the following elements may be added: sodium, potassium, rubidium. cesium, beryllium, calcium, strontium, and barium. In some embodiments, oxides of one or more of the following may be used: oxides of one or more transition metals (atomic numbers 21-30, 39-48, and 57-80), and oxides of one or more elements in Groups III-A, IV-A, V-A, and VI-A of the Periodic Table. One or more mixed oxides, such as CaCrO₃, BaTiO₃, SrVO₃, and ZrO₂ mixed with up to 10% Y₂O₃ by weight. may also be used in some embodiments. Of the aforementioned oxides, the following are currently preferred: oxides of calcium, barium, zinc, tin, indium, silicon, strontium, titanium, copper, and chromium; Fe₃O₄. and Al₂O₃. The oxide in the alloy/oxide mixture may constitute from about 5% to 80%, and preferably about 20% to 60%. of the mixture by weight.

### 2. Method of Making Hydrogen Storing Nickel Alloy Structures

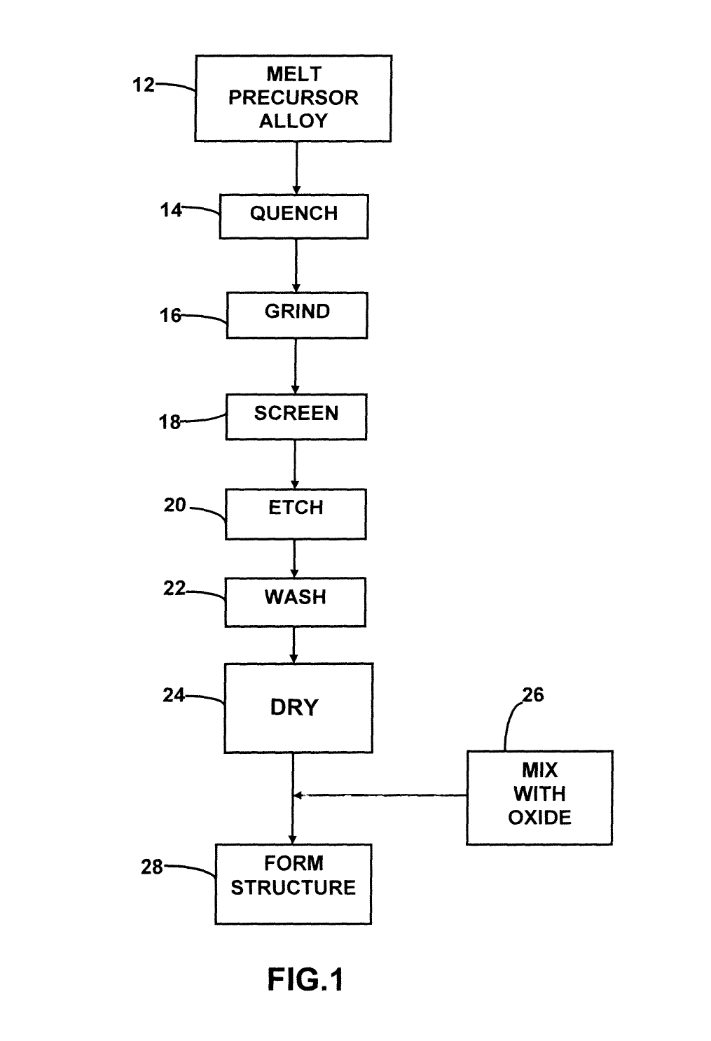

For use in the energy generating apparatus described below, the above-described nickel alloys, in powder form, are mixed with a powdered oxide and formed into a hydrogen storing nickel alloy structure. Nickel alloy powders can be made by a variety of processes, such as, for example, gas atomization, in which an alloy melt is blown into a powder by a jet of inert gas. For the purposes of this disclosure, it is preferred to use a process that is a modification of the type of process that is commonly used to make skeletal catalysts. An exemplary process 10 of this type is illustrated in the flowchart of FIG. 1.

First, in step 12. a precursor alloy is melted, preferably in a vacuum induction furnace or the functional equivalent. The precursor alloy may be any of the alloys mentioned above, but it is preferably about 50% nickel by weight. with the balance being either pure aluminum, or aluminum mixed with one or more of silicon, carbon, and boron. For the purposes of the following discussion, it will be assumed that an exemplary precursor alloy of 50% Ni and 50% Al is used.

The melted alloy, or “melt,” is then subjected to fast quenching to room temperature (step 14), and then it is ground into a powder (step 16). The powder is then screened (step 18) to the desired particle size. Preferably, the particle size of the screened powder ranges from about 20 nm to about 50 microns.

Next, in step 20, the screened powder is etched with an etchant comprising about 15% to 25% by weight (20% preferred) concentrated NaOH or KOH, at about 70° C. to about 110° C. for a sufficient time to remove most of the elemental aluminum. What remains is a nickel alloy powder composed of fine particles of porous nickel alloyed with about 5% to 15% aluminum by weight, with some aluminum oxide on the surface of the particles. In this state, the nickel alloy powder is a nickel skeletal catalyst or sponge metal catalyst similar to the product marketed under the trademark RANEY® Nickel by W. R. Grace & Co. Corporation-Connecticut, of New York, N.Y., USA. If one or more of silicon. carbon, and boron is included in the precursor alloy. as mentioned above, the nickel alloy powder will contain some of whichever of these elements was in the precursor alloy. At this point, the powder may be termed a “nickel alloy skeletal catalyst powder.”

The nickel alloy skeletal catalyst powder is washed and cleaned in de-ionized, de-aerated water (step 22), and it may be stored in water as a slurry. When it is desired to fabricate a hydrogen-storing nickel alloy structure, the slurry is dried (step 24) in a de-oxygenated gaseous environment (e.g., nitrogen or argon) to its powder form, in which it is mixed with one or more of the oxides described above (step 26) to form a nickel alloy/oxide powder.

Finally, a nickel alloy hydrogen storage structure is formed (step 28). The structure may be formed by pressing or otherwise forming the nickel alloy/oxide powder into any desired configuration. The configuration may be, for example, that of a cylindrical slug, a bar, or a plate. The resulting structure may be provided with lead wires (preferably nickel), or it may be drawn or pressed directly into the form of a wire, thereby obviating the need for lead wires. Alternatively, the structure may be formed by pressing the nickel alloy/oxide powder onto a portion of a metal wire (preferably nickel wire) as a thin coating, leaving uncoated portions at either end of the coated portion as leads. As still another alternative, the nickel alloy/oxide powder is cold-pressed onto one or more thin metal foil sheets (preferably of nickel), whereby the powder forms a thin coating on the foil. Still another alternative is to form the powder directly into the configuration of one or more thin sheets, such as by cold rolling a plate formed of the powder. The configurations described herein are exemplary only, and are not exclusive.

If the nickel alloy/oxide powder is cold-drawn into a wire configuration or cold-rolled into a sheet configuration. a reduction ratio of at least 90% is preferred. The cold drawing or cold rolling is followed by annealing in a vacuum at an elevated temperature, preferably in the range of about 600° C. to 900° C. This will produce a nearly full density structure with a preferred {100} orientation.

Another method of forming the hydrogen storage structure is to prepare the nickel alloy/oxide powder as a coating on a nickel substrate using a vapor deposition process, such as, for example, sputtering, ion plating, and thermal evaporation. Preferably, the substrate is oriented so that the {100} plane is parallel to the substrate surface, whereby the coating will have the same preferred orientation.

A wrought form of the nickel alloy can also be made by a powder metallurgy technique, in which powders of the various metallic and (optional) oxide ingredients are mixed together. The mixed powders are subject to cold-pressing, or to cold isostatic pressing and sintering. or to hot isostatic pressing, to form a slug or pellet. The resulting slug or pellet may be subjected to various metal-shaping processes, such as, for example, hot forging or hot rolling. Preferably. the processed slug or pellet is then annealed in a vacuum, followed by quenching to room temperature. For these powder metallurgy techniques, the nickel alloy is first powdered by a suitable powder metallurgy process, such as, for example, gas atomization. In gas atomization, the nickel alloy, in a melted liquid state, is caused to flow through a small-diameter nozzle and then subjected to a pressurized jet of nitrogen or argon to form small droplets. which are cooled into solid particles. The resultant nickel alloy powder may then be mixed with any of the oxides mentioned above in a mechanism such as a high energy mill. Such a mill typically employs balls of silicon dioxide or aluminum oxide as the grinding medium, in the presence of water.

### 3. Generation of Thermal Energy

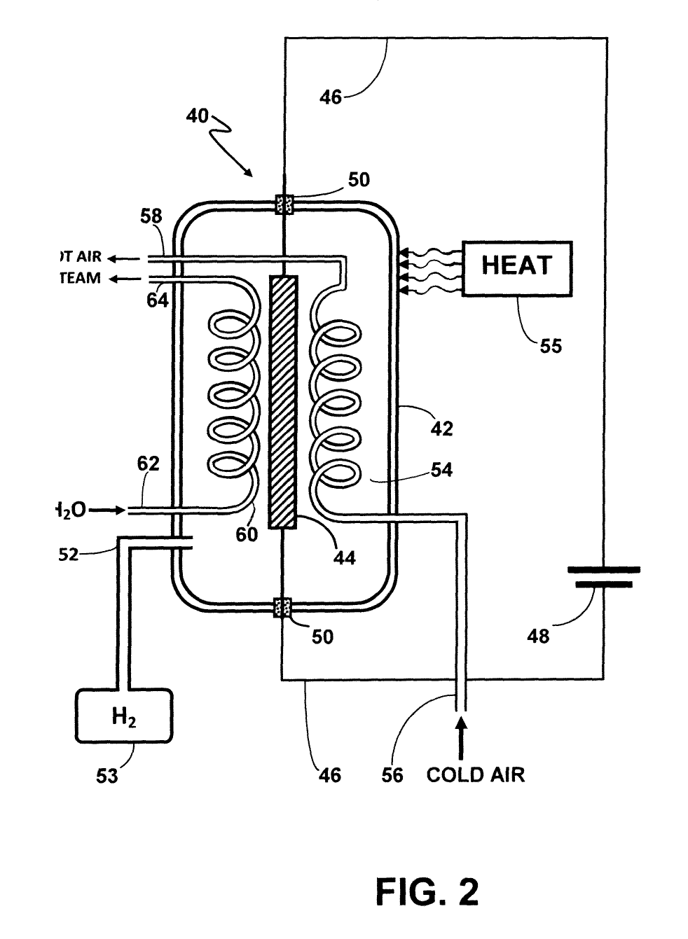

FIG. 2 illustrates a reactor 40 in which thermal energy is generated using a nickel alloy hydrogen storage structure of the type described above. The reactor includes a reactor vessel 42, which may be made of a suitable metal or ceramic material capable of containing pressurized hydrogen. The vessel 42 is gas-tight and able to withstand elevated temperatures. A nickel alloy hydrogen storage structure 44 is contained within the vessel 42. connected by conductive wires 46 (preferably of nickel) to a voltage source 48 that applies a suitable potential across the storage structure 44. As shown, the hydrogen storage structure 44 is in the form of a generally cylindrical slug, but it may be any of the configurations described above. The voltage source 48 may be DC (as shown) or AC. If the latter, the frequency may be standard 50-60 Hz, or as low as 0.001 Hz, or as high as 1 MHz. A gas-tight insulative seal 50 is provided in the wall of the vessel 42 at each of the points through which one of the wires 46 connecting the storage structure 44 to the voltage source 48 passes.

The vessel 42 is evacuated by means such as a vacuum pump (not shown), and it includes a hydrogen inlet 52 through which pressurized hydrogen gas is introduced to the interior of the vessel 42 from a pressurized hydrogen gas source 53. The hydrogen is preferably at a purity of at least about 99.95%, with a natural isotope distribution. The vessel 42 is filled at room temperature with hydrogen to a pressure of between that is preferably between about 1 and 10 bar, and more preferably between about 5 and 10 bar.

The hydrogen storage structure 44 is heated by a suitable heating means 55 to a temperature of between about 100° C. to about 1000° C., preferably between about 250° C. to about 500° C. The heating means 55 may be, for example, an electrical resistance element (e.g. a heating coil of nichrome wire), an ultrasonic heating mechanism, a magnetic field induction element, or any other suitable heating mechanism. With the application of heat to the reactor vessel 42, the gas pressure of the hydrogen within the reactor vessel 42 should be in the range of about 10 to 1000 bar, preferably between about 10 and 300 bar, and more preferably between about 10 and 100 bar.

Under the conditions described above, the nickel alloy hydrogen storage structure 44 absorbs a high concentration of molecular hydrogen at sufficiently elevated temperature and pressure to induce a reaction of the hydrogen and nickel nuclei to a degree that generates thermal energy in the form of phonons, thereby releasing heat in addition to that which is required to elevate the temperature of the vessel 42.

The release of phonons in the above-described reaction generates “excess” thermal energy that can be used to produce superheated air or steam in a heat exchanger provided in the reactor vessel 42. Thus, for example, an air heat exchanger may include an air heat exchange tube 54 in the vessel 42, wherein the air heat exchange tube 54 receives room temperature air from an air inlet 56 and discharges heated air through an air outlet 58. The heated air may be used, for example, for space heating or, if hot enough, to heat a water heater (not shown) to provide hot water for commercial or domestic use. Likewise, a water heat exchanger may include a water heat exchange tube 60 in the vessel 42, wherein the water heat exchange tube 60 receives room temperature water through a water inlet 62 and discharges steam through a steam outlet 64. The steam may be used for space heating. If the steam is superheated (e.g., to a temperature exceeding about 250° C.) by having the water heat exchanger subjected to elevated pressure, the superheated steam discharged from the steam outlet 64 may be directed to a steam turbine (not shown) to drive an electric generator (not shown), as is well-understood in the art.

### 4. Example 1

A precursor nickel-aluminum alloy is made with a composition, by weight, of 0.03% carbon (maximum), 40% aluminum, 10% silicon, 3%-4% molybdenum, the balance nickel. The alloy is melted by a process that minimized potential contamination by sulfur or phosphorous, e.g., either vacuum induction melting or electroslag re-melting. The alloy melt is quenched to room temperature at a cooling rate of at least about 100° C. per second in a vacuum, or in an inert gas (e.g., argon) or nitrogen. The quenched alloy is crushed or ground into a powder by a conventional process, and the alloy powder is screened to a particle size not exceeding 10 microns. The screened powder particles are leached in 20% by weight NaOH at about 104° C. to about 108° C. for about 2 hours, while undergoing mechanical agitation by conventional means. After leaching the NaOH is decanted, and the leached powder particles are repeatedly washed with deionized and de-aerated water until a near-neutral pH value is attained.

The resultant nickel alloy powder, which is now a “nickel alloy skeletal catalyst,” has particles with a surface area of about 40-50 m²/gm. It is normally mixed with and stored in de-aerated water to form a slurry. The slurry is dried in a de-oxygenated environment to form a powder, which is mixed. in a blender filled with nitrogen or an inert gas (e.g., argon), with 25% by weight of Fe₃O₄ (magnetite) particles with an average particle size of about 100 nm. The resultant nickel alloy/oxide powder is cold pressed into a hydrogen-storing nickel alloy structure having a generally cylindrical configuration, of about 3-4 mm in diameter and about 6-8 mm in length. The structure so formed is bonded to a pair of nickel lead wires of about 1 mm diameter, and then it is installed in a reactor vessel, as described above, made of 316L stainless steel or the proprietary Ni—Mo—Cr—Fe alloy marketed under the trademark Hastelloy® C-276 by Haynes International, Inc. of Kokomo, Ind., USA.

The interior chamber of the vessel is charged with hydrogen gas. The chamber of the vessel is heated by an external heat source (as described above) to about 400° C., elevating the pressure of the hydrogen to about 100 bar, and a DC potential of about 1V is applied across the wired slug. Under these conditions, heat energy, in the form of phonons, is generated by the reaction of the nuclei of hydrogen molecules absorbed by the slug with the nuclei of the nickel in the slug. Thermal energy is generated by this process at a higher rate than is generated by (a) the resistance heating of the hydrogen-storing nickel alloy structure by the electric current created by the application of the electric potential across it. and (b) the heat applied to the reactor vessel by the external heat source.

### 5. Example 2

The second example is the same as Example 1, except that the precursor alloy is (by weight) 40% aluminum. 10% silicon. 10% cobalt, 3%-4% molybdenum, the balance nickel.

1. A method of making a hydrogen-storing nickel alloy structure, the method comprising:
(a) providing a nickel alloy skeletal catalyst powder;
(b) mixing the nickel alloy skeletal catalyst powder with a powdered oxide to form a nickel alloy/oxide powder; and
(c) forming the nickel alloy/oxide powder into a hydrogen storing nickel alloy structure.

2. The method of claim 1, wherein the nickel alloy skeletal catalyst powder is formed from a precursor alloy that comprises approximately 35%-50% by weight nickel, the remainder being one or more metals selected from the group consisting of aluminum, lithium, zinc, molybdenum, manganese, titanium, iron, chromium, and cobalt, and one or more materials selected from the group consisting of boron, carbon and silicon.

3. The method of claim 1, wherein the powdered oxide constitutes about 5% to about 80% by weight of the nickel alloy/oxide powder and is selected from a group consisting of one or more of barium oxide, strontium oxide, and calcium oxide.

4. The method of claim 1, wherein the nickel alloy skeletal catalyst powder comprises at least about 80% by weight nickel.

5. The method of claim 4, wherein the nickel alloy skeletal catalyst powder further comprises not more than about 15% by weight of one or more metals selected from the group consisting of aluminum, lithium, zinc, molybdenum, manganese, titanium, iron, chromium, and cobalt, and not more than about 10% by weight of one or more materials selected from the group consisting of boron, carbon and silicon.

6. The method of claim 2, wherein the precursor alloy comprises, by weight, approximately 40% aluminum, 10% silicon, 3%-4% molybdenum, and the balance nickel.

7. The method of claim 6, wherein the precursor alloy further includes, by weight, a maximum of 0.03% carbon.

8. The method of claim 6, wherein the nickel alloy skeletal catalyst powder includes particles comprising about 5%-15% elemental aluminum by weight, with aluminum oxide on the surface of the particles.

9. The method of claim 2, wherein the precursor alloy comprises, by weight, approximately 40% aluminum, 10% silicon, 10% cobalt, 3%-4% molybdenum, and the balance nickel.

10. The method of claim 9, wherein the nickel alloy skeletal catalyst powder includes particles comprising about 5%-15% elemental aluminum by weight, with aluminum oxide on the surface of the particles.

11. Apparatus for the generation of thermal energy, comprising:
a gas-tight reactor vessel having a gas inlet configured to receive pressurized hydrogen gas from a pressurized hydrogen gas source;
a hydrogen-storing nickel alloy structure contained within the reactor vessel, wherein the hydrogen-storing nickel alloy structure comprises a mixture of a nickel alloy skeletal catalyst powder and a powdered oxide;
a voltage source electrically connected to the hydrogen-storing nickel alloy structure so as to apply a voltage across it; and
a heating device operatively associated with the reactor vessel so as to apply heat to the vessel.

12. (canceled)

13. The apparatus of claim 11, wherein the nickel alloy skeletal catalyst powder is formed from a precursor alloy that comprises approximately 35%-50% by weight nickel, the remainder being one or more metals selected from the group consisting of aluminum, lithium, zinc, molybdenum, manganese, titanium, iron, chromium, and cobalt, and one or more materials selected from the group consisting of boron, carbon and silicon.

14. The apparatus of claim 11, wherein the powdered oxide constitutes about 5% to about 80% by weight of the mixture and is selected from a group consisting of one or more of barium oxide, strontium oxide, and calcium oxide.

15. The apparatus of claim 11, wherein the nickel alloy skeletal catalyst powder comprises at least about 80% by weight nickel.

16. The apparatus of claim 15, wherein the nickel alloy skeletal catalyst powder further comprises not more than about 15% by weight of one or more metals selected from the group consisting of aluminum, lithium, zinc, molybdenum, manganese, titanium, iron, chromium, and cobalt, and not more than about 10% by weight of one or more materials selected from the group consisting of boron, carbon and silicon.

17. The apparatus of claim 16, wherein the nickel alloy skeletal catalyst powder includes particles comprising about 5%-15% elemental aluminum by weight, with aluminum oxide on the surface of the particles.

18. (canceled)

19. A method of generating thermal energy, comprising:
(a) providing a reactor vessel containing a hydrogen-storing nickel alloy structure comprising a mixture of a nickel alloy skeletal catalyst powder and a powdered oxide;
(b) filling the reactor vessel with hydrogen;
(c) increasing the pressure of the hydrogen in the reactor vessel by heating the reactor vessel to a temperature of at least 100° C.; and
(d) while heating the reactor vessel, applying an electric potential across the hydrogen-storing nickel alloy structure that is sufficient, at the increased pressure of the hydrogen in the reactor vessel, to result in the absorption of hydrogen by the hydrogen-storing nickel alloy structure in a manner that creates a nuclear reaction between hydrogen nuclei and nickel nuclei in the hydrogen-storing nickel alloy structure, wherein the thermal energy is generated by the nuclear reaction in the form of phonons emitted from the hydrogen-storing nickel alloy structure.

20. (canceled)

21. (canceled)

22. The method of claim 19, wherein the nickel alloy skeletal catalyst powder is formed from a precursor alloy that comprises approximately 35%-50% by weight nickel, the remainder being one or more metals selected from the group consisting of aluminum, lithium, zinc, molybdenum, manganese, titanium, iron, chromium, and cobalt, and one or more materials selected from the group consisting of boron, carbon and silicon.

23. The method of claim 19, wherein the powdered oxide constitutes about 5% to about 80% by weight of the mixture and is selected from a group consisting of one or more of barium oxide, strontium oxide, and calcium oxide.

24. The method of claim 19, wherein the nickel alloy skeletal catalyst powder comprises at least about 80% by weight nickel.

25. The method of claim 24, wherein the nickel alloy skeletal catalyst powder further comprises not more than about 15% by weight of one or more metals selected from the group consisting of aluminum, lithium, zinc, molybdenum, manganese, titanium, iron, chromium, and cobalt, and not more than about 10% by weight of one or more materials selected from the group consisting of boron, carbon and silicon.

26. The method of claim 25, wherein the nickel alloy skeletal catalyst powder includes particles comprising about 5%-15% elemental aluminum by weight, with aluminum oxide on the surface of the particles.

27. The method of claim 19, wherein the temperature is approximately 400° C.

28. The method of claim 19, wherein the electric potential is applied by a DC voltage source.

29. The method of claim 19, wherein the electric potential is applied by an AC voltage source with a frequency in the range of about 0.001 Hz to about 1 MHz.

30. The method of claim 19, wherein the pressure of the hydrogen in the reactor vessel is increased to about 100 bar in response to the application of heat.

31. The method of claim 30, wherein the temperature is approximately 400° C., and wherein the applied electric potential is applied as a DC voltage.

32. A hydrogen-storing nickel alloy structure, comprising:
a nickel alloy skeletal catalyst; and
an oxide.

33. The hydrogen-storing nickel alloy structure of claim 32, wherein the nickel alloy skeletal catalyst is formed from a precursor alloy that comprises approximately 35%-50% by weight nickel, the remainder being one or more metals selected from the group consisting of aluminum, lithium, zinc, molybdenum, manganese, titanium, iron, chromium, and cobalt, and one or more materials selected from the group consisting of boron, carbon and silicon.

34. The hydrogen-storing nickel alloy structure of claim 32, wherein the nickel alloy skeletal catalyst comprises at least about 80% nickel by weight.

35. The hydrogen-storing nickel alloy structure of claim 34, wherein nickel alloy skeletal catalyst further comprises not more than about 15% by weight of one or metals selected from the group consisting of aluminum, lithium, zinc, molybdenum, manganese, titanium, iron, chromium, and cobalt, and not more than about 10% by weight of one or more materials selected from the group consisting of boron, carbon and silicon.

36. The hydrogen-storing nickel alloy structure of claim 33, wherein the precursor alloy comprises, by weight, approximately 40% aluminum, 10% silicon, 3%-4% molybdenum, and the balance nickel.

37. The hydrogen-storing nickel alloy structure of claim 36, wherein the precursor alloy further includes, by weight, a maximum of 0.03% carbon.

38. The hydrogen-storing nickel alloy structure of claim 36, wherein the nickel alloy skeletal catalyst includes about 5%-15% elemental aluminum by weight, with aluminum oxide on the surface of the particles.

39. The hydrogen-storing nickel alloy structure of claim 33, wherein the precursor alloy comprises, by weight, approximately 40% aluminum, 10% silicon, 10% cobalt, 3%-4% molybdenum, and the balance nickel.

40. The hydrogen-storing nickel alloy structure of claim 39, wherein the nickel alloy skeletal catalyst is a powder including particles comprising about 5%-15% elemental aluminum by weight, with aluminum oxide on the surface of the particles.

41. The hydrogen-storing nickel alloy structure of claim 32, wherein the oxide is an oxide of an element selected from a group consisting of one or more of strontium, barium, and calcium.

42. The hydrogen-storing nickel alloy structure of claim 32, wherein the oxide is an oxide of an element selected from a group consisting one or more of indium, silicon, and aluminum.

43. The hydrogen-storing nickel alloy structure of claim 32, wherein the oxide is an oxide of an element selected from a group consisting of one or more of sodium, potassium, rubidium, cesium, and beryllium.

44. The hydrogen-storing nickel alloy structure of claim 32, wherein the oxide is an oxide of an element selected from a group consisting of one or more of the elements with atomic numbers 21-30, 39-48, and 57-80, and elements in Groups III-A, IV-A, V-A, and VI-A of the Periodic Table.

45. The hydrogen-storing nickel alloy structure of claim 32, wherein the oxide is selected from a group consisting of one or more of CaCrO₃, BaTiO₃, SrVO₃, and ZrO₂ mixed with up to 10% Y₂O₃ by weight.

46. The hydrogen storing nickel alloy structure of claim 32, wherein the oxide is selected from a group consisting of one or more of an oxide of zinc, an oxide of tin, an oxide of titanium, an oxide of copper, an oxide of chromium, and Fe₃O₄.
